(19) United States
(12) Patent Application Publication
(10) Pub. No.: US 2017/0197801 A1
(43) Pub. Date: Jul. 13, 2017

(54) Tape Applicator Having Blade Protection Device

(71) Applicant: Hsiu-Man Yu Chen, Taichung City (TW)

(72) Inventor: Hsiu-Man Yu Chen, Taichung City (TW)

(21) Appl. No.: 14/992,747

(22) Filed: Jan. 11, 2016

(51) Int. Cl. B65H 35/00; B26F 3/02

(52) U.S. Cl. CPC B65H 35/0086; B26F 3/02; B65H 35/0026

(57) ABSTRACT

A tape applicator having a blade protection device is provided. The tape applicator includes a tape applicator main body and a protection cover. One end of the protection cover is provided with a pivotal member for the protection cover to be pivotally connected to the tape applicator main body. The pivotal member has a first plane and a second plane relative to a top surface of the blade. Thereby, by turning the protection cover, the protection cover can be positioned on the top surface of the blade via the first plane or the second plane, such that the protection cover can cover or expose the blade. The user won't touch the cutting edge of the blade by accident when the tape applicator is not used. The present invention provides a protection effect so as to enhance the safety of the tape applicator.

### BACKGROUND OF THE INVENTION

### 1. Field of the Invention

The present invention relates to a tape applicator, and more particularly to a tape applicator having a blade protection device.

### 2. Description of the Prior Art

A conventional hand-held tape applicator comprises a base. The base is provided with a raised receiving axle for placement of a tape roll. One end of the base is provided with a serrated blade. When in use, the user holds the base of the hand-held tape applicator and the tape is pulled out to be adhered to an article. After that, the tape applicator is deflected an angle for the blade to cut the tape totally. This operation way is easy and convenient to enhance the convenience for taping articles.

However, although it is easy and convenient to operate the aforesaid hand-held tape applicator, the blade of the aforesaid hand-held tape applicator is exposed out of the base, which may hurt the user when the hand-held tape applicator is used or not used. This lowers the safety of the hand-held tape applicator greatly. As a result, the aforesaid hand-held tape applicator is not safe for use. Accordingly, the inventor of the present invention has devoted himself based on his many years of practical experiences to solve these problems.

### SUMMARY OF THE INVENTION

The primary object of the present invention is to provide a tape applicator having a blade protection device adapted to cover the blade of the tape applicator so as to enhance the safety of the tape applicator.

In order to achieve the aforesaid object, the blade protection device of the present invention is disposed on a tape applicator main body. The tape applicator main body has a cutting portion at one end thereof. The cutting portion is provided with a blade. The blade protection device includes a protection cover, a first positioning position, and a second positioning position. One end of the protection cover is provided with a pivotal member for the protection cover to be pivotally connected to the tape applicator main body. The pivotal member has a turning axis. The pivotal member has a first plane and a second plane relative to a top surface of the blade. At the first positioning position, the protection cover can be positioned on the top surface of the blade via the first plane, and the protection cover covers the cutting edge of the blade. At the second positioning position, the protection cover can be positioned on the top surface of the blade via the second plane, and the cutting edge of the blade is exposed out of the protection cover.

The protection cover of the blade protection device of the tape applicator of the present invention can be turned and positioned at the first positioning position, such that the protection cover can cover the blade totally when not in use. In this way, the user won't touch the cutting edge of the blade by accident. The present invention provides a protection effect so as to enhance the safety of the tape applicator.

### BRIEF DESCRIPTION OF THE DRAWINGS

FIG. 1 is a perspective view of the present invention;

FIG. 2 is an exploded view of the present invention;

FIG. 3 is a side view of a protection cover of the present invention;

FIG. 4 is a schematic view showing the use state of the present invention at the first positioning position;

FIG. 5 is a schematic view showing the use state of the present invention at the second positioning position; and

FIG. 6 is a schematic view showing the use state of the present invention at the third positioning position.

### DETAILED DESCRIPTION OF THE PREFERRED EMBODIMENTS

Embodiments of the present invention will now be described, by way of example only, with reference to the accompanying drawings.

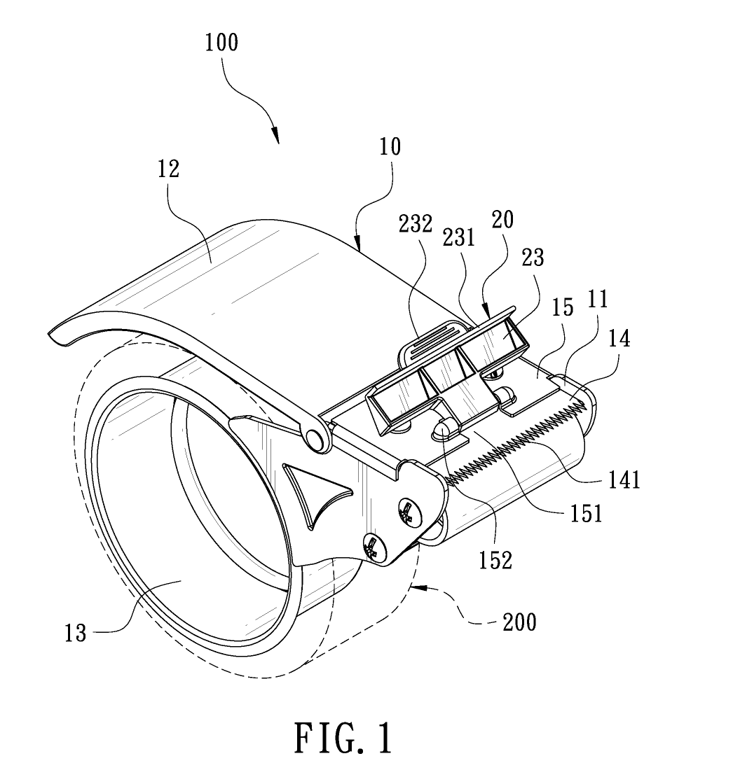

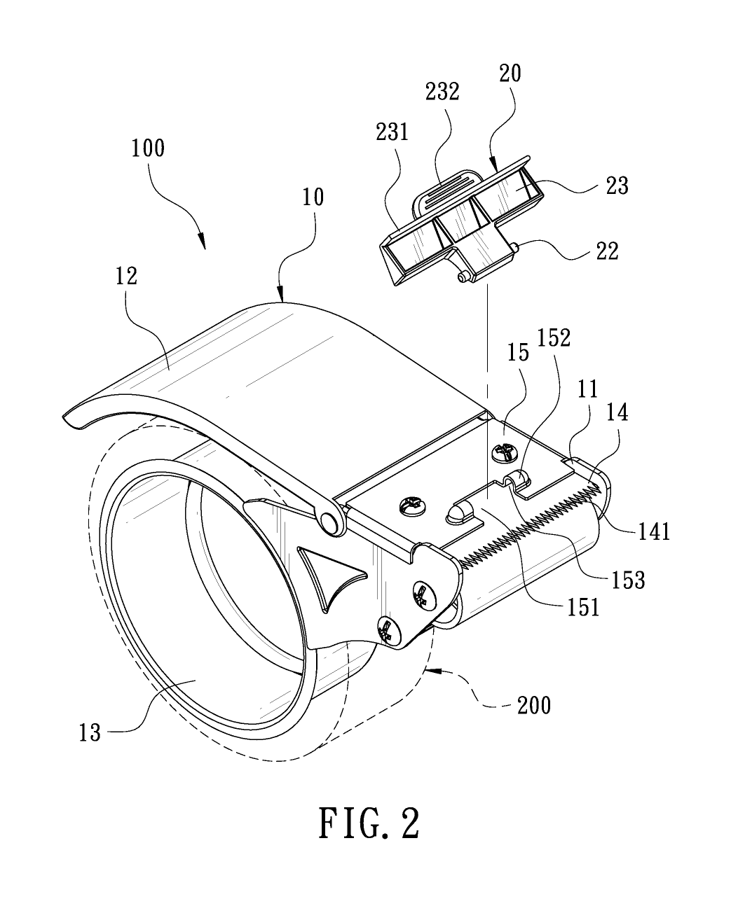

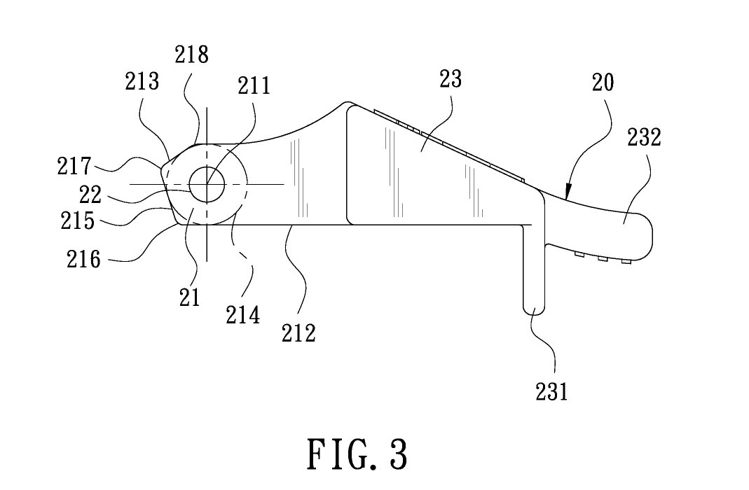

FIG. 1 is a perspective view of the present invention. FIG. 2 is an exploded view of the present invention. FIG. 3 is a side view of a protection cover of the present invention. The present invention discloses a tape applicator 100 having a blade protection device. The tape applicator 100 comprises a tap applicator main body 10 and a protection cover 20. The tap applicator main body 10 has a cutting portion 11 at one end thereof, a grip portion 12 at another end thereof, and a receiving portion 13 under the grip portion 12 for placement of a tape roll 200. The cutting portion 11 is provided with a blade 14. The blade 14 has a cutting edge 141 which is a serrated edge. The cutting portion 11 is further provided with a lid 15 to cover the blade 14. The cutting edge 141 of the blade 14 is exposed out of the lid 15. The lid 15 is formed with a notch 151. The lid 15 is provided with a pair of pivotal blocks 152 at two sides of the notch 151. Each of the pair of pivotal blocks 152 has a pivotal hole 153.

One end of the protection cover 20 is provided with a pivotal member 21 for the protection cover 20 to be pivotally connected to the tape applicator main body 10. In an embodiment of the present invention, the pivotal member 21 is a pivotal block. The pivotal member 21 has a turning axis 211. The pivotal member 21 has a first plane 212 and a second plane 213 relative to a top surface of the blade 14. A circle 214 is defined by the turning axis 211 of the pivotal member 21 as the center of the circle 214. The circle 214 is tangent to the first plane 212 and the second plane 213, respectively. The pivotal member 21 of the protection cover 20 further has a third plane 215 between the first plane 212 and the second plane 213. The third plane 215 is tangent to the circle 214. The pivotal member 21 has a first turning corner 216 between the first plane 212 and the third plane 215. The pivotal member 21 has a second turning corner 217 between the second plane 213 and the third plane 215. The distance from the first turning corner 216 to the turning axis 211 is greater than the radius of the circle 214. The distance from the second turning corner 217 to the turning axis 211 is also greater than the radius of the circle 214. The pivotal member 21 further has a third turning corner 218 at another end of the second plane 213 relative to the second turning corner 217. The distance from the third turning corner 218 to the turning axis 211 is greater than the radius of the circle 214. In addition, the pivotal member 21 of the protection cover 20 is provided with a pair of pivots 22 relative to the pivotal holes 153 of the pair of pivotal blocks 152. The pivots 22 are pivoted about the turning axis 211. Another end of the protection cover 20 is provided with a covering 23. The covering 23 is adapted to cover the cutting edge 141 of the blade 14. The covering 23 is provided with a vertical board 231 relative to the cutting edge 141 of the blade 14. The covering 23 is provided with a pull block 232 extending from an outer side of the vertical board 231.

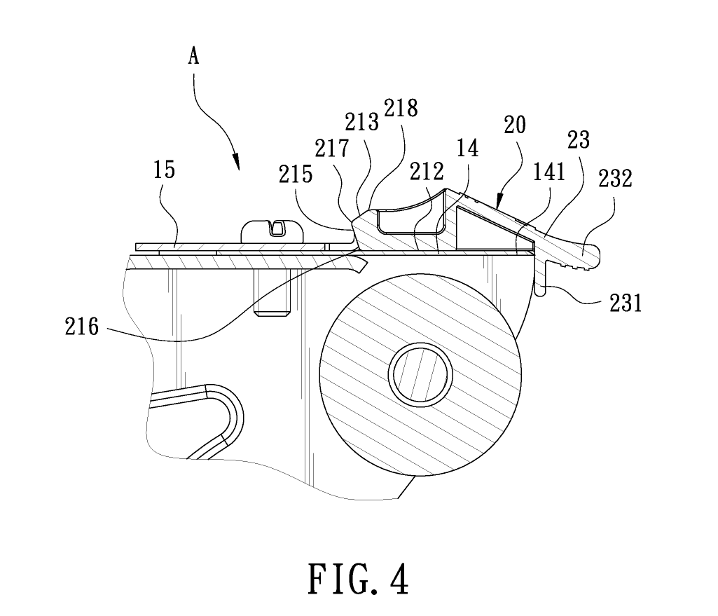

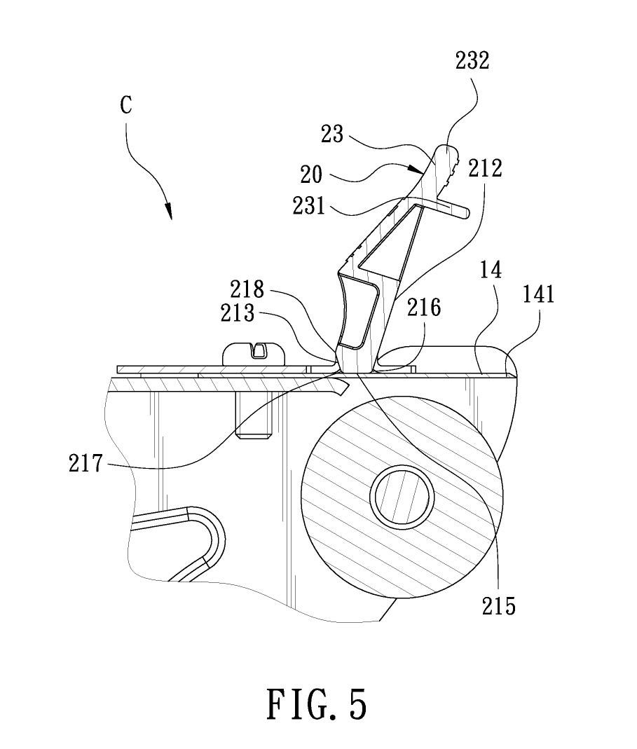

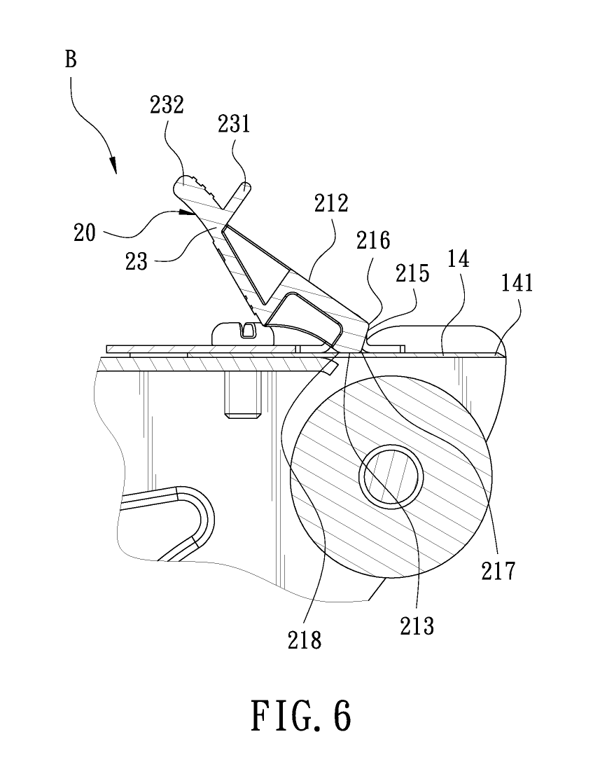

FIG. 4 is a schematic view showing the use state of the present invention at the first positioning position. FIG. 5 is a schematic view showing the use state of the present invention at the second positioning position. FIG. 6 is a schematic view showing the use state of the present invention at the third positioning position. The protection cover 20 can be selectively positioned at three positioning positions, a first positioning position A, a second positioning position B, and a third positioning position C.

At the first positioning position A, the protection cover 20 is positioned on the top surface of the blade 14 via the first plane 212, and the protection cover 20 covers the cutting edge 141 of the blade 14.

At the second positioning position B, the protection cover 20 is positioned on the top surface of the blade 14 via the second plane 213, and the cutting edge 141 of the blade 14 is exposed out of the protection cover 20.

At the third positioning position C, the protection cover 20 is positioned on the top surface of the blade 14 via the third plane 215, and the cutting edge 141 of the blade 14 is half exposed out of the protection cover 20.

The structural features, technical means of use, and expected effects of the present invention are described hereinafter.

FIG. 4 is a schematic view showing the use state of the present invention at the first positioning position. When the tape applicator 100 is not used, the protection cover 20 is positioned at the first positioning position A. The first plane 212 is positioned on the top surface of the blade 14, enabling the protection cover 20 to cover the cutting edge 141 of the blade 14. When the tape applicator 100 is used, the pull block 232 of the covering 23 is pulled by the user to lift the protection cover 20 upward. Because the pivots 22 are pivotally connected to the pivotal holes 153, the protection cover 20 can be pivoted about the turning axis 211. When the protection cover 20 is turned to the first turning corner 216, the first turning corner 216 is interfered with the blade 14. The lid 15 is slightly raised, such that the protection cover 20 is positioned at the third positioning position C and the third plane 215 is positioned on the top surface of the blade 14. The protection cover 20 can be rotated for turning. After turning, as shown in FIG. 5, the blade 14 is half exposed out of the protection cover 20. After that, the protection cover 20 is rotated in the same direction. When the protection cover 20 is turned to the second turning corner 217, the second turning corner 217 is interfered with the blade 14. The lid 15 is slightly raised, enabling the protection cover 20 to be rotated for turning. After turning, as shown in FIG. 6, the protection cover 20 is positioned at the second positioning position B and the second plane 213 is positioned on the top surface of the blade 14. The cutting edge 141 of the blade 14 is exposed out of the protection cover 20, such that the tape pulled from the tape roll 200 can be cut for use.

Thereby, when the tape applicator 100 is not used, the protection cover 20 is positioned at the first positioning position A, enabling the protection cover 20 to cover the cutting edge 141 of the blade 14, so that the user won't touch the cutting edge 141 of the blade 14 by accident. When the tape applicator 100 is used, the protection cover 20 can be positioned at the second positioning position B or the third positioning position C so that the cutting edge 141 of the blade 14 is exposed for cutting the tape. The present invention provides a protection effect so as to enhance the safety of the tape applicator 100.

It is noted that the distance from each of the first turning corner 216, the second turning corner 217, and the third turning corner 218 to the turning axis 211 is greater than the radius of the circle 214. The protection cover 20 can be positioned at the first positioning position A via the first plane 212 in cooperation with the first turning corner 216. The protection cover 20 can be positioned at the third positioning position C via the third plane 215 in cooperation with the first turning corner 216 and the second turning corner 217. Finally, the protection cover 20 can be positioned at the second positioning position B via the second plane 213 in cooperation with the second turning corner 217 and the third turning corner 218. The protection cover 20 can be turned to bring a three-section positioning effect.

It is noted that one end of the protection cover 20 is provided with the covering 23. The covering 23 is adapted to cover the cutting edge 141 of the blade 14. The covering 23 is provided with the vertical board 231 relative to the cutting edge 141 of the blade 14. The covering 23 is provided with the pull block 232 extending from the outer side of the vertical board 231. Thereby, when the protection cover 20 is at the first positioning position A, the vertical board 231 is to cover the cutting edge 141 of the blade 14 totally. The protection cover 20 can be turned by pulling the pull block 232 to prevent the user from being hurt.

In this embodiment of the present invention, the three positioning planes and the three turning corners are only for examples. The number of the positioning planes and the turning corners can be changed, without departing from the scope of the present invention.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A tape applicator having a blade protection device, the blade protection device being disposed on a tape applicator main body, the tape applicator main body having a cutting portion at one end thereof, the cutting portion being provided with a blade, characterized in that the blade protection device includes:
a protection cover, wherein one end of the protection cover is provided with a pivotal member for the protection cover to be pivotally connected to the tape applicator main body, the pivotal member has a turning axis, and the pivotal member has a first plane and a second plane relative to a top surface of the blade;
a first positioning position, wherein the protection cover is selectively positioned on the top surface of the blade via the first plane, and the protection cover covers the cutting edge of the blade; and
a second positioning position, wherein the protection cover is selectively positioned on the top surface of the blade via the second plane, and the cutting edge of the blade is exposed out of the protection cover.

2. The tape applicator having a blade protection device as claimed in claim 1, wherein a circle is defined by the turning axis of the pivotal member as the center of the circle, and the circle is tangent to the first plane and the second plane, respectively.

3. The tape applicator having a blade protection device as claimed in claim 2, wherein the pivotal member has a first turning corner between the first plane and the second plane, and a distance from the first turning corner to the turning axis is greater than the radius of the circle.

4. The tape applicator having a blade protection device as claimed in claim 2, wherein the pivotal member of the protection cover further has a third plane between the first plane and the second plane, the third plane is tangent to the circle, the blade protection device has a third positioning position, the protection cover is selectively positioned on the top surface of the blade via the third plane, and the cutting edge of the blade is half exposed out of the protection cover.

5. The tape applicator having a blade protection device as claimed in claim 4, wherein the pivotal member has a first turning corner between the first plane and the third plane, the pivotal member has a second turning corner between the second plane and the third plane, a distance from the first turning corner to the turning axis is greater than the radius of the circle, and a distance from the second turning corner to the turning axis is greater than the radius of the circle.

6. The tape applicator having a blade protection device as claimed in claim 5, wherein the pivotal member has a third turning corner at another end of the second plane relative to the second turning corner, and a distance from the third turning corner to the turning axis is greater than the radius of the circle.

7. The tape applicator having a blade protection device as claimed in claim 1, wherein the cutting portion is provided with a lid to cover the blade, the cutting edge of the blade is exposed out of the lid, the lid is formed with a notch, the lid is provided with a pair of pivotal blocks at two sides of the notch, each of the pair of pivotal blocks has a pivotal hole, the pivotal member of the protection cover is provided with a pair of pivots relative to the pivotal holes of the pair of pivotal blocks, and the pivots are pivoted about the turning axis.

8. The tape applicator having a blade protection device as claimed in claim 1, wherein another end of the protection cover is provided with a covering, the covering is provided with a vertical board relative to the cutting edge of the blade, and the covering is provided with a pull block extending from an outer side of the vertical board.

9. The tape applicator having a blade protection device as claimed in claim 1, wherein the cutting edge of the blade is a serrated edge.
